(19) United States
(12) Patent Application Publication
(10) Pub. No.: US 2019/0301621 A1
(43) Pub. Date: Oct. 3, 2019

(54) SHOWER DIVERTER

(71) Applicants: Fred Guindi, North Brunswick, NJ (US); Alexander Tran, North Brunswick, NJ (US)

(72) Inventors: FRED GUINDI, North Brunswick, NJ (US); Alexander Tran, North Brunswick, NJ (US)

(73) Assignee: HDS TRADING CORP., North Brunswick, NJ (US)

(21) Appl. No.: 15/939,686

(22) Filed: Mar. 29, 2018

(51) Int. Cl. F16K 11/085; F16K 11/00

(52) U.S. Cl. CPC F16K 11/085; F16K 19/00

(57) ABSTRACT

The present invention provides a shower diverter for selectively connecting a single water source between at least two outlets. The shower diverter comprises a housing having an internal chamber, a water inlet port in fluid communication with the internal chamber and coupled to a water supply port, a first outlet port in fluid communication with the internal chamber; and a second outlet port in fluid communication with the internal chamber. The valve assembly is selectively actuated by a push button to move the valve assembly within the chamber between one of four positions.

### FIELD OF THE INVENTION

The present invention relates to a shower diverter with a valve assembly for selectively controlling the flow of water out of either a shower head output port, faucet output port, or a hand held shower nozzle output port, or any combination of two output ports.

### BACKGROUND OF THE INVENTION

Typical shower diverter valves are often utilized to control water flow from a bathtub faucet or a shower head. Also, diverter valves enable a user to selectively use the standard overhead shower, as well as a hand-held shower head for soaping and washing different parts of the body.

Shower diverter valves typically include knobs with either a rotary or push-pull mechanism actuatable by the user. Push-pull diverter valves typically use longitudinal movable seal members to selectively activate certain flow paths. However, rotary diverter valves utilize a seal that is mounted on a shaft rotatable about an axis to selectively activate certain fluid paths. In particular, the seal is used to block one of two outlet ports. The seal can be arranged between the outlet ports so that fluid from the inlet exits both outlet ports.

However, current shower diverters, including those with knobs having either a rotary or push-pull mechanism, often are small and difficult to grasp, and often require a significant amount of force to actuate the diverter. Thus, disabled people with musculoskeletal disorders such as arthritis have a difficult time operating these diverters and even experience pain in attempting to do so. In fact, the Americans with Disabilities Act (ADA) has established standards for acceptable design of facilities that sets a maximum limit on the amount of force a user of a facility can be required to impart in order to use that facility. Accordingly, architects and builders of public facilities are reluctant to include plumbing fixtures which require excessive force to operate them.

Accordingly, there is a need for a simple, robust, ergonomic, and reliable shower diverter that: requires a minimal amount of force to operate; supports water flow to a shower head, hand held massager, or to both, and that is easy to install.

### DESCRIPTION OF THE PRIOR ART

Many shower diverter valves have been devised in the past. The patents listed below are representative of the prior art.

U.S. Pat. No. 2,022,875 to Zinkil, et al. discloses using a sliding gate valve operated by a lift button.

U.S. Pat. No. 3,473,558 to Mongerson discloses using a cylindrical diverter sliding within an annular seal.

U.S. Pat. No. 3,124,162 to Cameron discloses a rotary valve. “One side wall of the valve body has a fitting for an inlet pipe and a plurality of fittings for outlet conduits are spaced angularly around the opposite side wall of the housing. Within the housing, a circular disc is journaled in bearings for rotation and for axial displacement longitudinally in the valve body. The disc has a single hole at the same radius from the central axis of the housing as the inlet and outlet fittings. A spring urges the disc away from the outlet fittings and an electric solenoid urges the disc toward the outlet fittings. Rotation of the disc is accomplished by a plurality of countersunk holes which are arranged on opposite sides of the disc. Pins are mounted in the housing in position to engage countersunk holes, so that when the disc is reciprocated by the spring or the solenoid, the pins engage the countersunk portions of the holes and by carnming action rotate the disc. Thus, by alternately energizing and deenergizing the solenoid, the disc indexes from one outlet conduit to the next.”

U.S. Pat. No. 4,628,962 to Pezzarossi discloses a diverter valve of the type having a valve body with a cylindrical cavity having inlet and outlet openings and a valve stem having a cylindrical rotatable core portion and a seal sleeve made of elastomeric material and incorporating a metal insert.

U.S. Pat. No. 5,624,073 to Muller, et al, discloses “a cleaning attachment system which can coupled between a water outlet and a showerhead. The system includes a diverter valve, flexible conduit, a coupling at a first end of the conduit for attaching the conduit in fluid communication with the diverter valve and a nozzle attached to a second end of the flexible conduit.”

U.S. Pat. No. 7,299,510 to Tsai discloses a holder attached to a water outlet extending from a wall that includes a housing having an inlet attached to the water outlet and two or more outlet ports for attaching a shower head and a sprayer nozzle. The housing includes an attaching device for the sprayer nozzle and a controlling device to control the water to flow through the outlet ports. The housing includes a partition secured thereto, the attaching device is rotatably attached to the partition. The partition includes a bore formed therein, a follower rotatably engaged in the bore of the partition secured to the attaching device.

U.S. Pat. No. 8,474,482 to Melle discloses a switching valve that switches between at least two different outlets with the aid of a valve closing body and a valve seat. The valve contains an actuating device that can be actuated by the user, which includes a pushbutton, is configured for moving the valve closing body. The valve closing body is designed as a plate element that interacts with a partition in the valve housing.

None of the aforementioned prior art references disclose or teach the basic structure of a push button shower diverter with minimal moving parts for selectively controlling the flow of water between one of four discreet positions out of either a shower head output port, faucet output port, or a hand held shower nozzle output port, or any combination of two output ports.

### OBJECTS OF THE INVENTION

It is an object of the present invention to provide an improved diverter valve having a pushbutton to ergonomically and selectively control the water flow between four discreet positions which include water flowing through the shower head, hand held shower nozzle or massager, or to both at the same time.

It is an object of the present invention to provide an improved diverter valve having a pushbutton that requires a minimum amount of force to selectively control the water flow between four discreet positions and only the use of one hand operation to switch between functions

It is another object of the present invention to provide an improved diverter valve having a minimal number of moving parts, including an actuator shaft about which is attached a spring, a rotatable circular disc having notches along the circumference of the disc, and a cylindrical push button.

Another object of this present invention is that it does not require drilling holes into the bathroom tile/wall in order to hold both a shower head and massager since it holds both of them right off the shower pipe.

Still another object of the present invention is that because the structure of the invention permits the massager holder to be placed atop the unit, it can create a rain-like effect from any basic shower.

### SUMMARY OF THE INVENTION

The present invention provides a shower diverter for selectively connecting a single water source between at least two outlets. The shower diverter comprises a housing having an internal chamber, a water inlet port in fluid communication with the internal chamber and coupled to a water supply port, a first outlet port in fluid communication with the internal chamber; and a second outlet port in fluid communication with the internal chamber. The valve assembly is selectively actuated by a push button to move the valve assembly within the chamber between one of four of the following positions: (a) a first position at which the valve assembly permits fluid communication between the water inlet port and the first outlet port while inhibiting fluid communication between the water inlet port and the second outlet port, (b) a second position at which the valve assembly permits fluid communication between the water inlet port and the first and second outlet ports; (c) a third position at which the valve assembly permits fluid communication between the water inlet port and the second outlet while inhibiting fluid communication between the water inlet port and the first outlet port; or (d) a fourth position at which the valve assembly permits fluid communication between the water inlet port and the first and second outlet ports.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a side perspective view of the shower diverter showing the push button side of the shower diverter housing;

FIG. 2 is a side perspective view of the shower diverter showing the opposite side of the shower diverter housing;

FIG. 3 is a side perspective view of the shower diverter showing the opposite side of the shower diverter with the side housing removed and further showing the cover of the valve assembly;

FIG. 4 is a side perspective view of the shower diverter showing the opposite side of the shower diverter with the side housing and the cover of the valve assembly removed and further showing the valve assembly in a first position;

FIG. 5 is a side perspective view of the shower diverter showing the opposite side of the shower diverter with the side housing and the cover of the valve assembly removed and further showing the valve assembly in a second position;

FIG. 6 is a side perspective view of the shower diverter showing the opposite side of the shower diverter with the side housing and the cover of the valve assembly removed and further showing the valve assembly in a third position;

FIG. 7 is a side perspective view of the shower diverter showing the opposite side of the shower diverter with the side housing and the cover of the valve assembly removed and further showing the valve assembly in a fourth position;

FIG. 8 is a side perspective view of the shower diverter showing the opposite side of the shower diverter with the side housing and the cover of the valve assembly removed and further showing the four gear teeth of the gear shaft and the first and second arcuate openings of the valve assembly;

FIG. 8A 8 is a side perspective view of the shower diverter showing the opposite side of the shower diverter with the side housing and the cover of the valve assembly removed and further showing the central cylindrical opening and the first and second arcuate openings of the valve assembly;

FIG. 9 is a side perspective view of the push button side of the shower diverter showing the side housing removed and further showing the first end of the gear shaft of the valve assembly;

FIG. 10 is a cross sectional view of the of the shower diverter showing the push button actuation of the valve assembly

FIG. 10A is an additional side perspective view of the push button side of the shower diverter;

FIG. 11 is a top side perspective view of the actuator shaft attached to the spring ad the top end of the rotatable shaft of the valve assembly;

FIG. 12 is a bottom side perspective view of the actuator shaft attached to the second bottom end of the rotatable circular disc, and further showing the four gear teeth of the rotatable disc of the valve assembly; and

FIG. 13 is an exploded perspective view of the actuator shaft attached to the rotatable disc, the gear shaft and the push button of the valve assembly;

FIG. 14 is a side perspective view of the shower diverter showing the opposite side of the shower diverter with the side housing and the cover of the valve assembly removed and further showing the water flow direction with the valve assembly in a first position;

FIG. 15 is a side perspective view of the shower diverter showing the opposite side of the shower diverter with the side housing and the cover of the valve assembly removed and further showing the water flow direction with the valve assembly in a second position;

FIG. 16 is a side perspective view of the shower diverter showing the opposite side of the shower diverter with the side housing and the cover of the valve assembly removed and further showing the water flow direction with the valve assembly in a third position;

FIG. 17 is a side perspective view of the shower diverter showing the opposite side of the shower diverter with the side housing and the cover of the valve assembly removed and further showing the water flow direction with the valve assembly in a fourth position;

### DETAILED DESCRIPTION OF THE PREFERRED EMBODIMENT

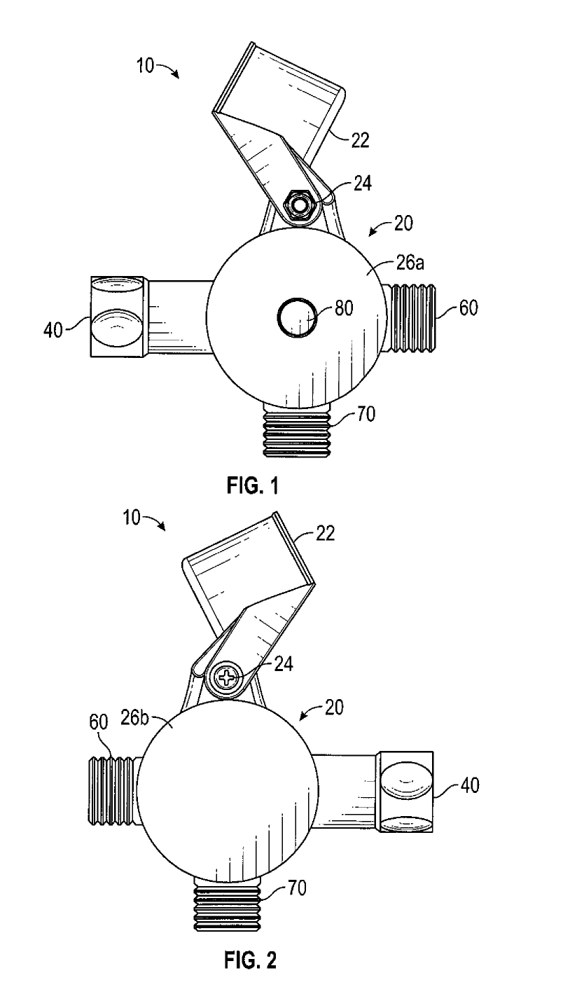

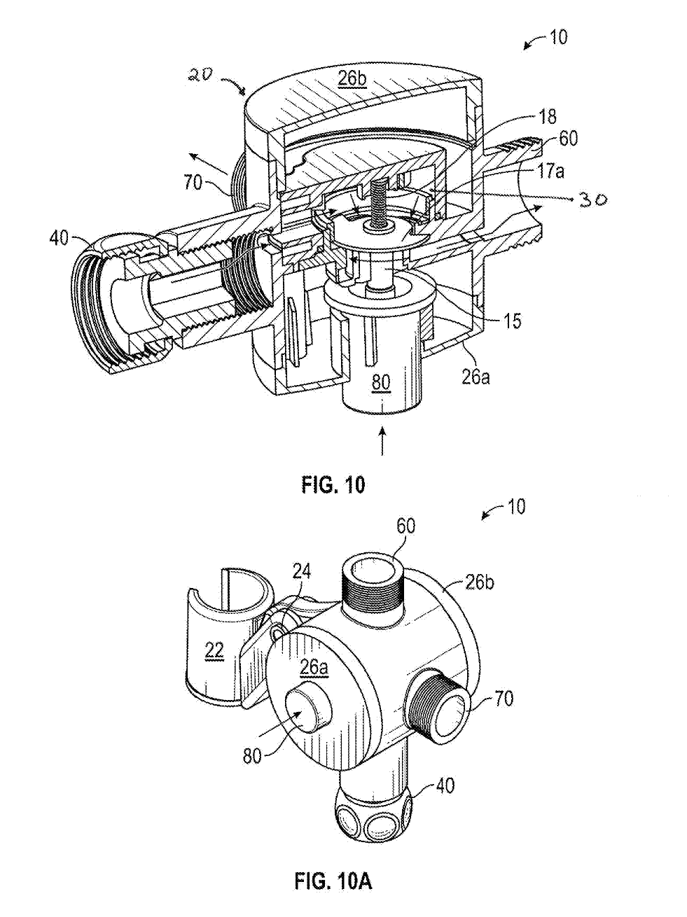

As shown in FIGS. 1 through 17, the present invention in a preferred embodiment provides a shower diverter 10 for selectively connecting a single water source between at least two outlets. As best shown in FIG. 10, the shower diverter 10 comprises a housing 20 having an internal chamber 30 and a water inlet port 40. Further, the water inlet port 40 is in fluid communication with the internal chamber 30 for coupling to a water supply port. A first outlet port 60 is in fluid communication with the internal chamber 30; and a second outlet port 70 is also in fluid communication with the internal chamber 30. Furthermore, the exterior of the housing is preferably cylindrical in shape, but can be of any suitable shape. The cylindrical housing 20 has a first button side 26a and a second back side 26b. Thus, this simple shower diverter construction does not require drilling holes into the bathroom tile/wall in order to hold both a shower head and massager since this shower diverter construction holds both of them right off the shower pipe.

As shown in FIGS. 1 and 2, the exterior of the housing is further attached to a holder for a hand held shower nozzle or massager 22. Preferably the housing is attached to the holder for a hand held shower nozzle or massager 22 by a hinge 24. Since the massager holder 22 is placed atop the housing 20, the hand held shower nozzle or massager 22 can create a rain-like effect from any basic shower.

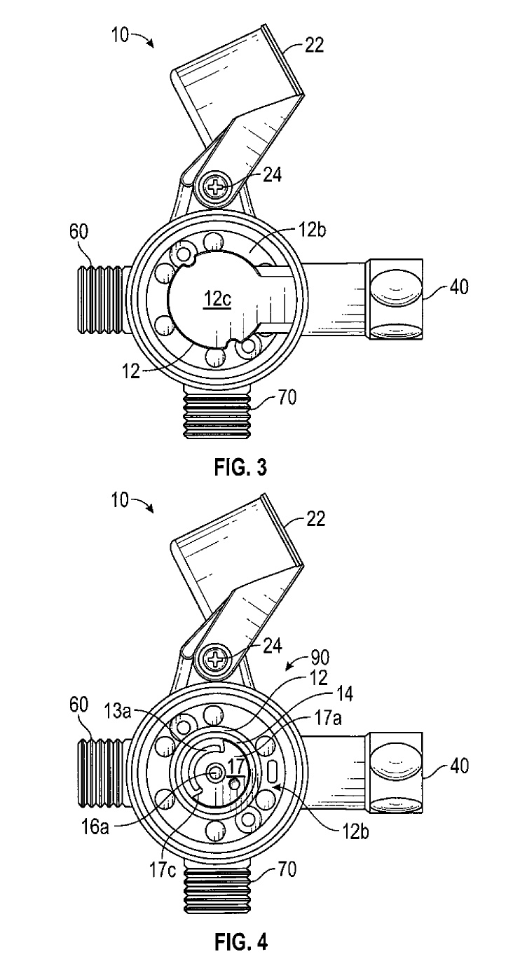

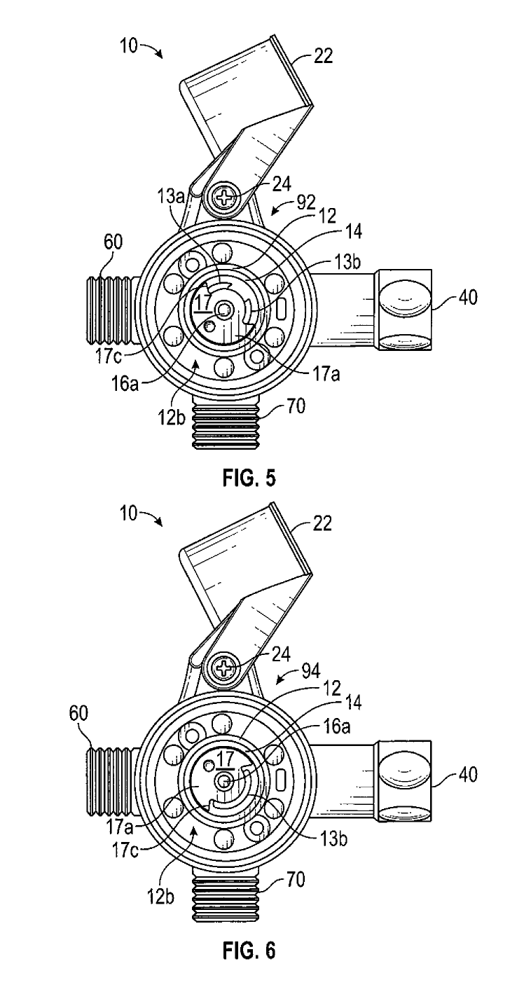

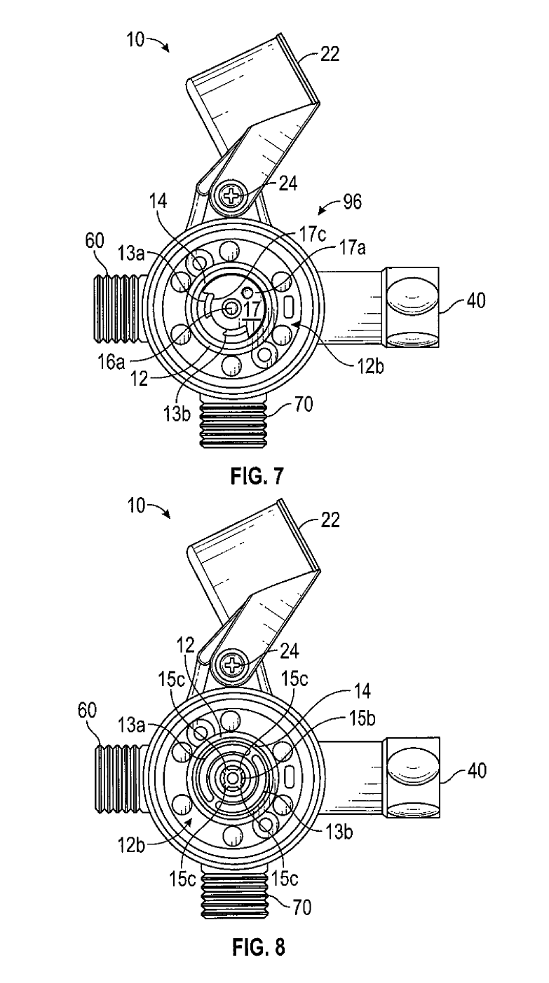

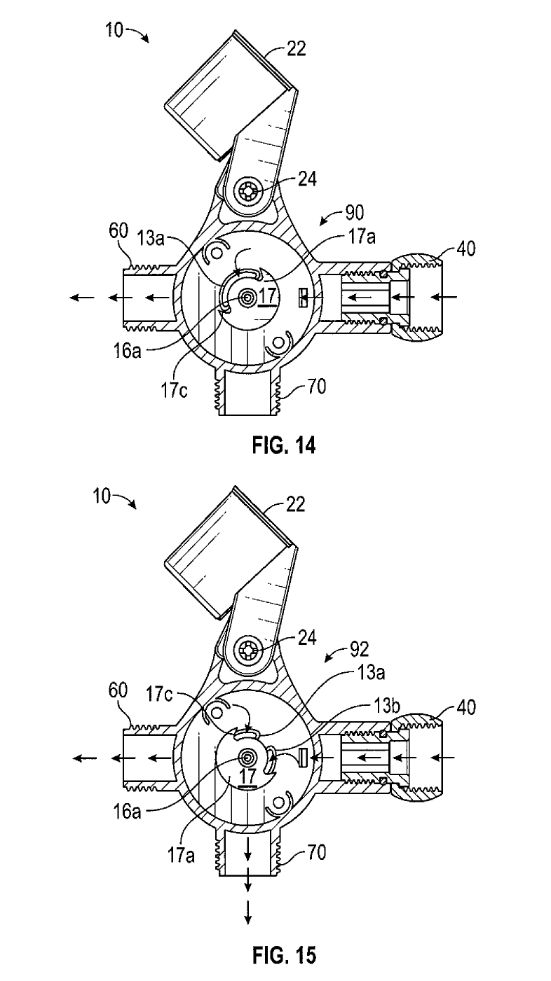

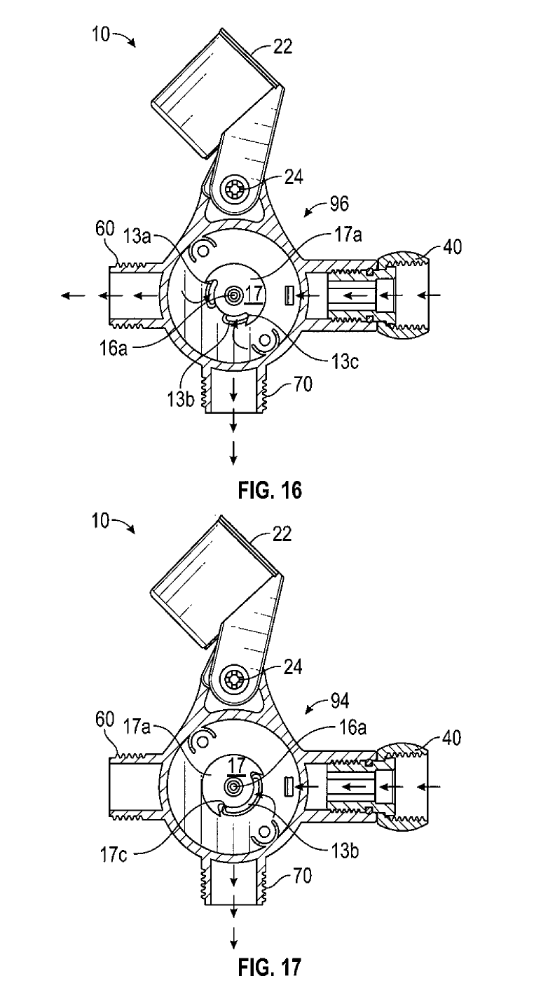

As shown in FIGS. 3 through 17, a valve assembly 12 within the housing 20 is also provided that is selectively actuated by a push button 80 to move the valve assembly within the chamber between one of four of the following positions: (a) a first position 90, as shown in FIGS. 4 and 14, at which the valve assembly permits fluid communication between the water inlet port 40 and the first outlet port 60 while inhibiting fluid communication between the water inlet port 40 and the second outlet port 70, (b) a second position 92, as shown in FIGS. 5 and 15, at which the valve assembly permits fluid communication between the water inlet port 40 and the first and second outlet ports 60 and 70; (c) a third position 94, as shown in FIGS. 6 and 16, at which the valve assembly permits fluid communication between the water inlet port 40 and the second outlet port 70 while inhibiting fluid communication between the water inlet port 40 and the first outlet port 60; or (d) a fourth position 96, as shown in FIGS. 7 and 17, at which the valve assembly permits fluid communication between the water inlet port 40 and the first and second outlet ports 60 and 70.

Preferably, and as shown in FIGS. 4 through 7, 10A, and 14 through 17, the water inlet port 40 is in parallel fluid communication with the first outlet port 60 and the water inlet port 40 is in perpendicular fluid communication with the second outlet port 70. Also, the first outlet port 60 is preferably in perpendicular fluid communication with the second outlet port 70. However, in different embodiments the water inlet port 40 can be in perpendicular fluid communication with the first outlet port 60 and in parallel fluid communication with the second outlet port 70. Also, in different embodiments the first outlet port 60 can be in parallel fluid communication with the second outlet port 70. In addition, the first outlet port 60 and the second outlet port 70 can be selectively connected to and be in fluid communication with a shower head output port, faucet output port, or a hand held shower nozzle output port.

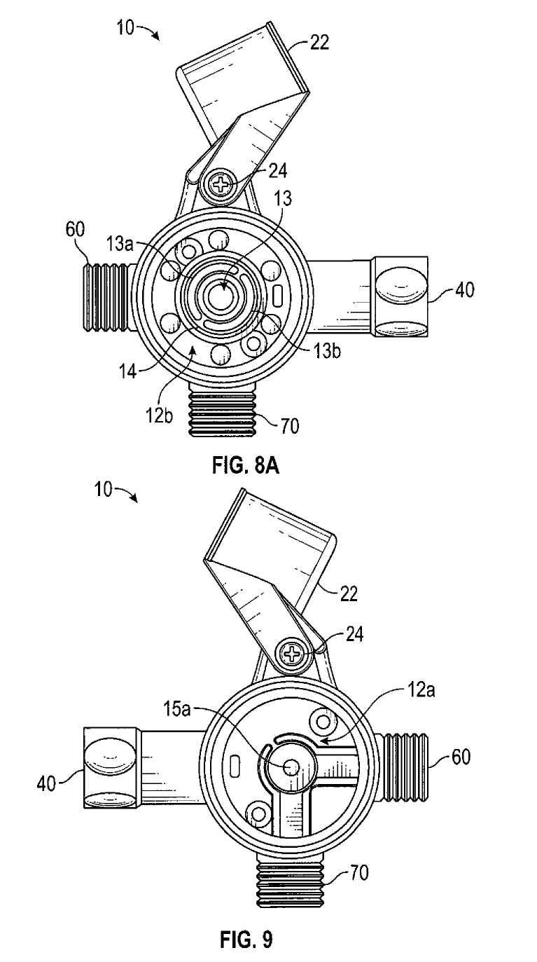

As shown in FIGS. 3 through 9 and 14 through 17, the valve assembly 12 further includes a first valve side 12a (shown in FIG. 9) which faces the first button side 26a of the housing 20 and a second valve side 12b (shown in FIGS. 3 through 8A and 14 through 17) which faces the second back side 26b of the housing 20. As shown in FIG. 8A. the valve assembly 12 also includes a central cylindrical hollow recess 13 which runs through the center of the valve assembly from the first valve side 12a to the second valve side 12b. As shown in FIG. 3, on the second valve side 12b of the valve assembly 12 is a cover 12c. Beneath the cover 12c and as shown in FIGS. 4 through 8A, is a circular indentation 14 which surrounds the central cylindrical hollow opening 13. Within the circular indentation 14 are a first arcuate opening 13a and a second arcuate opening 13b which oppose each other about the central cylindrical hollow opening 13.

As shown in FIGS. 8, 9, 10, and 13, a cylindrical gear shaft 15 extends from the first valve side 12a through the central cylindrical hollow opening 13 to the second valve side 12b. As best shown in FIG. 13, the first end of the gear shaft 15a is connected to the push button 80 on the first valve side 12a. The second end of the gear shaft 15b is hollow and is surrounded by four gear teeth 15c.

Further, as shown in FIGS. 4 through 7, 10, 11, and as best shown in FIGS. 12 and 13, an actuator shaft 16 is provided which is attached to a spring 18 at the first end of the actuator shaft 16a. Also, a rotatable circular disc 17 having a semicircular notch 17c along the circumference of the disc is attached to the center of the actuator shaft 16b. The second end of the actuator shaft 16c is received in and mateably engages with the second hollow end of the gear shaft 15b.

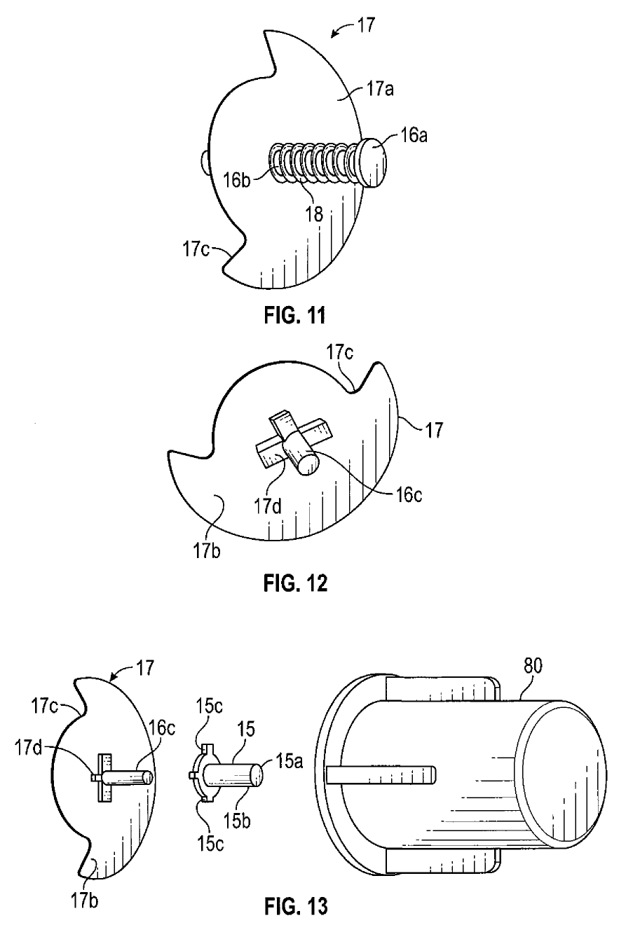

In addition, as shown in FIGS. 4 through 7, and 10 through 17, and as best shown in FIGS. 11 through 13, the rotatable circular disc 17 has a first top end 17a and a second bottom end 17b. The first top end of the rotatable circular disc 17a is in perpendicular alignment with the spring 18 about the first end of the actuator shaft 16a. The second bottom end of the rotatable circular disc 17b contains four gear teeth 17d as shown in FIGS. 12 and 13, and is in perpendicular alignment with the second end of the actuator shaft 16c. As shown in FIG. 13, the four gear teeth of the rotatable circular disc 17d are mateably engagable with the four gear teeth of the second end of the gear shaft 15c when the second end of the actuator shaft 16c is received in and mateably engages with the second hollow end of the gear shaft 15b.

In operation, when the push button 80 is pressed a first time, as shown in FIGS. 4 through 7, 14, and as best shown in FIGS. 10, and 11 through 13, a force is exerted on the first end of the gear shaft 15a. This is turn causes the four gear teeth of the second end of the gear shaft 15c to in turn exert a force on the four gear teeth of the second bottom end of the rotatable circular disc 17d. The spring 18 attached to the first end of the actuator shaft 16a then exerts an opposing force on the gears 15c and 17d which cause each of the opposing four gear teeth 15c and 17d to rotate a quarter turn and advance into successive mateable positions. This causes the circular disc 17 to rotate about the actuator shaft 16. The circular disc 17 rotates such that the semicircular notch of the disc 17c exposes the first arcuate opening 13a and the remainder of the circular disc covers and seals the second arcuate opening 13b. This is the first position 90 (shown in FIGS. 4 and 14) discussed above wherein the valve assembly 12 permits fluid communication between the water inlet port 40 and the first outlet port 60 while inhibiting fluid communication between the water inlet port 40 and the second outlet port 70.

In a similar fashion described above, and as shown in FIGS. 5, 10, 11 through 13, and 15, when the push button 80 is pressed a second time, the circular disc 17 rotates such that the semicircular notch of the disc 17c exposes the top half of the first arcuate opening 13a and the top half of the second arcuate opening 13b. The remainder of the circular disc covers and seals the bottom half of the first arcuate opening 13a and the bottom half of the second arcuate opening 13b. This is the second position 92 (shown in FIGS. 5 and 15) discussed above wherein the valve assembly permits fluid communication between the water inlet port 40 and the first and second outlet ports 60 and 70.

Also, in a similar fashion described above, and as shown in FIGS. 6, 10, 11 through 13, and 16, when the push button 80 is pressed a third time, the circular disc 17 rotates such that the semicircular notch of the disc 17c exposes the second arcuate opening 13b and the remainder of the circular disc covers and seals the first arcuate opening 13a. This is the third position 94 (shown in FIGS. 6 and 16) discussed above wherein the valve assembly permits fluid communication between the water inlet port 40 and the second outlet port 70 while inhibiting fluid communication between the water inlet port 40 and the first outlet port 60.

Finally, in a similar fashion described above, and as shown in FIGS. 7, 10, 11 through 13, and 17, when the push button 80 is pressed a fourth time, the circular disc 17 rotates such that the semicircular notch of the disc 17c exposes the bottom half of the first arcuate opening 13a and the bottom half of the second arcuate opening 13b. The remainder of the circular disc covers and seals the top half of the first arcuate opening 13a and the top half of the second arcuate opening 13b. This is the fourth position 96 (shown in FIGS. 7 and 17) discussed above wherein the valve assembly permits fluid communication between the water inlet port 40 and the first and second outlet ports 60 and 70.

In the specification the terms “comprise, comprises, comprised and comprising” or any variation thereof and the terms “include, includes, included and including” or any variation thereof are considered to be totally interchangeable and they should all be afforded the widest possible interpretation.

In addition, numerous modifications, alterations, and changes to the described embodiments are possible without departing from the scope of the claimed invention, as defined in the claims and their equivalents thereof. Thus, it is intended that the claimed invention not be limited by the described embodiments above, but that it be defined by the have the full scope of the following claims.

### Advantages of the Present Invention

It is an advantage of the present invention to provide an improved diverter valve having a pushbutton to ergonomically and selectively control the water flow between four discreet positions which include water flowing through the shower head, hand held shower nozzle or massager, or to both at the same time.

It is an advantage of the present invention to provide an improved diverter valve having a pushbutton that requires a minimum amount of force to selectively control the water flow between four discreet positions and only the use of one hand operation to switch between functions

It is another advantage of the present invention to provide an improved diverter valve having a minimal number of moving parts, including an actuator shaft about which is attached a spring, a rotatable circular disc having notches along the circumference of the disc, and a cylindrical push button.

Another advantage of this present invention is that it does not require drilling holes into the bathroom tile/wall in order to hold both a shower head and massager since it holds both of them right off the shower pipe.

Still another advantage of the present invention is that because the structure of the invention permits the massager holder to be placed atop the unit, it can create a rain-like effect from any basic shower.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A shower diverter for selectively connecting a single water source between at least two outlets, comprising:
a. a housing having an internal chamber;
b. a water inlet port in fluid communication with said internal chamber and coupled to a water supply port;
c. a first outlet port in fluid communication with said internal chamber; and
d. a second outlet port in fluid communication with said internal chamber;
e. a valve assembly selectively actuated by a push button to move said valve assembly within said chamber between one of four of the following positions:
i. a first position at which said valve assembly permits fluid communication between said water inlet port and the first outlet port while inhibiting fluid communication between said water inlet port and said second outlet port; or
ii. a second position at which said valve assembly permits fluid communication between said water inlet port and the first and second outlet ports; or
iii. a third position at which said valve assembly permits fluid communication between said water inlet port and the second outlet port while inhibiting fluid communication between said water inlet port and said first outlet port; or
iv. a fourth position at which said valve assembly permits fluid communication between said water inlet port and the first and second outlet ports.

2. A shower diverter in accordance with claim 1, wherein said valve assembly includes an actuator shaft attached to a spring, a rotatable circular disc having a semicircular notch attached to said actuator shaft along the circumference of said disc, a gear shaft for controlling the rotation of said circular disc, and a cylindrical push button connected to said gear shaft, wherein actuation of said push button causes rotation of said circular disc about said actuator shaft which causes movement of said valve assembly between said four positions.

3. A shower diverter in accordance with claim 2, wherein said rotatable circular disc has four gear teeth on a first side of said disc and said gear shaft has four gear teeth on one side of said gear shaft, wherein said gear teeth of said circular disc are mateably engagable with said gear teeth of said gear shaft upon actuation of said push button.

4. A shower diverter in accordance with claim 1, wherein said first outlet port is connected to and is in fluid communication with a shower head output port, faucet output port, or a hand held shower nozzle output port.

5. A shower diverter in accordance with claim 1, wherein said second outlet port is connected to and is in fluid communication with a shower head output port, faucet output port, or a hand held shower nozzle output port.

6. A shower diverter in accordance with claim 1, wherein the exterior of said housing is further attached to a holder for a hand held shower nozzle or massager.

7. A shower diverter in accordance with claim 7, wherein said housing is hingedly attached to said holder for a hand held shower nozzle.

8. A shower diverter in accordance with claim 1, wherein said housing is cylindrical in shape.

9. A shower diverter in accordance with claim 1, wherein said water inlet port is in parallel fluid communication with said first outlet port.

10. A shower diverter in accordance with claim 1, wherein said water inlet port is in parallel fluid communication with said second outlet port.

11. A shower diverter in accordance with claim 1, wherein said water inlet port is in perpendicular fluid communication with said first outlet port.

12. A shower diverter in accordance with claim 1, wherein said water inlet port is in perpendicular fluid communication with said second outlet port.

13. A shower diverter in accordance with claim 1, wherein said first outlet port is in perpendicular fluid communication with said second outlet port.
